(19) United States
(12) Patent Application Publication
(10) Pub. No.: US 2008/0283308 A1
(43) Pub. Date: Nov. 20, 2008

(54) Device For Determining the Relative Position Between Two Essentially Flat Elements

(75) Inventors: Rainer Kurtz, Wertheim (DE); Mark Cannon, Weingarten (DE); Wolfram Hubsch, Frankfurt (DE); Harald Grumm, Munchen (DE)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: FRSA GmbH

(21) Appl. No.: 12/066,439

(22) PCT Filed: Aug. 11, 2006
(86) PCT No.: PCT/DE2006/001413

§ 371 Date: Jun. 12, 2008

(30) Foreign Application Priority Data
Sep. 13, 2005 (DE) 10 2005 043 833.4

(51) Int. Cl. G06F 3/041

(52) U.S. Cl. 178/18.01

(57) ABSTRACT

The invention pertains to a device for determining the relative position in the X-Y plane between two essentially flat elements that are spaced apart in the Z-direction and are essentially arranged on top of one another, wherein said device features at least one optical sensor that is arranged between the elements and is able to sense at least two points of the mutually facing surfaces of the elements, as well as an evaluation unit, in which the images of the points can be evaluated with respect to their relative position in the X-Y plane. In this case, the optical sensor features at least one line sensor that can be displaced relative to the two elements in such a way that the mutually facing surfaces of the elements can be optically scanned at least in sections in the manner of a scanner.

The invention pertains to a device according to the preamble of Claim 1 for determining the relative position in the X-Y plane between two essentially flat elements that are spaced apart in the Z-direction and are essentially arranged on top of one another.

Devices of this type are used, for example, in a screen or stencil printer for printing circuit boards or similar substrates with electric strip conductors in order to achieve a largely exact relative position between the stencil and the circuit board to be printed or the substrate to be printed, respectively, and to thusly ensure that the medium to be printed, for example, soldering paste or adhesive, exactly reaches the respective connection points provided on the circuit board during the printing through the stencil. In this respect, accuracies of less than 20 μm and less are required in practical applications.

In a device of the generic type that is known from EP 0 469 856 A3, a camera arrangement is placed between the two elements to be positioned relative to one another and said camera arrangement respectively determines two reference points on the mutually facing surfaces of the two elements. An evaluation unit compares the images of the reference points and subsequently calculates the precise positions of the reference points in relation to one another, wherein the thusly obtained coordinates are fed in the form of a correcting variable to an adjusting device that positions the two elements relative to one another in the X-Y direction such that the pairs of reference points respectively coincide with one another.

The disadvantages of this known device can be seen in that the reference points need to be defined anew for each variation or size of a circuit board or substrate such that the system needs to be “trained” or requires complicated adjustments when it is changed to a new circuit board model, and in that a sufficiently accurate coincidence of the stencil and the circuit board or substrate cannot be ensured with only a few pairs of reference points, particularly two pairs of reference points, due to the manufacturing tolerances of the substrate or circuit board. The so-called “circuit board stretching,” in particular, usually leads to a considerable offset that needs to be experimentally determined separately for each type of circuit board. This requires, in particular, a high monitoring expenditure and also results in a comparatively high reject rate.

Based on this state of the art, the present invention aims to develop a device of the initially described type that can be easily operated, has a simple design and an improved accuracy.

This objective is attained with a device according to the characteristics of Claim 1.

Advantageous embodiments of the invention form the objects of the dependent claims.

The device for determining the relative position in the X-Y plane between two essentially flat elements that are spaced apart from one another in the Z-direction and are essentially arranged on top of one another conventionally features at least one optical sensor that is arranged between the elements and is able to sense at least two points of the mutually facing surfaces of the elements. In this case, the X-Y plane is a plane that is respectively formed by the two elements or a plane extending parallel thereto. The Z-direction is the axis that extends perpendicular to the planes formed by the elements and therefore perpendicular to the X-Y plane.

In contrast to the state of the art, the optical sensor features at least one line sensor that can be displaced relative to the two elements in such a way that the mutually facing surfaces can be scanned optically at least in sections in the manner of a scanner. The line sensor is preferably realized in the form of a color line sensor.

In other words, this means that, in contrast to the state of the art, not the relative position of a few pairs of reference points is determined, but rather that surface regions of both elements are scanned in order to produce images. These images are then fed to an evaluation unit, in which they can be compared with respect to their relative position in the X-Y plane, for example, by means of automated software-controlled image comparison, wherein the thusly determined differences in position can be used as a correcting signal for a positioning device for the first and/or the second element. Since the actual differences in position between the elements are determined rather than the differences in position of individual reference points, the accuracy can be improved on the one hand and no training procedures are required when changing to different types and variations of elements on the other hand. Another decisive advantage of the inventive device is that an offset due to circuit board stretching no longer needs to be taken into consideration.

The line sensor can be stationarily arranged in basically arbitrary fashion, and the two elements to be scanned can be moved past the stationary line sensor. In this case, the only decisive aspect is a relative movement between the elements to be scanned and the line sensor. According to one particularly preferred embodiment of the invention, the line sensor is arranged on a carrier that can essentially be moved in the X-Y plane between the elements to be scanned by means of a drive. This makes it possible to easily scan a large region of the mutually facing surfaces of the elements.

According to another embodiment, the region to be scanned can be enlarged by arranging the line sensor on the carrier in a movable fashion.

It would be conceivable, in principle, to provide only one line sensor that initially scans the surface region of the first element to be scanned. Subsequently, the same line sensor is used for scanning the surface region of the second element to be scanned. This can be realized, for example, by initially scanning the first element with the line sensor during its pass through the gap between the two elements, wherein the line sensor is then essentially pivoted by 180 degrees on its carrier and subsequently scans the second element during the return pass. According to another embodiment, however, at least two line sensors are provided, wherein the at least two line sensors are preferably arranged on the carrier in such a way that a first line sensor points to the assigned surface of the first element and a second line sensor points to the assigned surface of the second element such that both elements can be scanned simultaneously in one pass.

The invention furthermore pertains to a system for printing circuit boards or substrates to be provided with electric strip conductors by means of a device according to one of the preceding claims, wherein the first of the two elements is constituted by a stencil and the second of the two elements is constituted by the circuit board to be printed or the substrate to be printed, respectively.

According to one preferred embodiment of this system, the device can still be used in the system after the printing of the circuit board or the substrate in order to check the print quality by scanning the printed circuit board in the printed region and once again comparing the thusly obtained image with a reference image in an evaluation unit. In this case, the check can be carried out while a following circuit board is simultaneously printed. This makes it possible to eliminate a separate downstream test device.

The invention is described in greater detail below with reference to only one embodiment that is illustrated in the figures. The figures show:

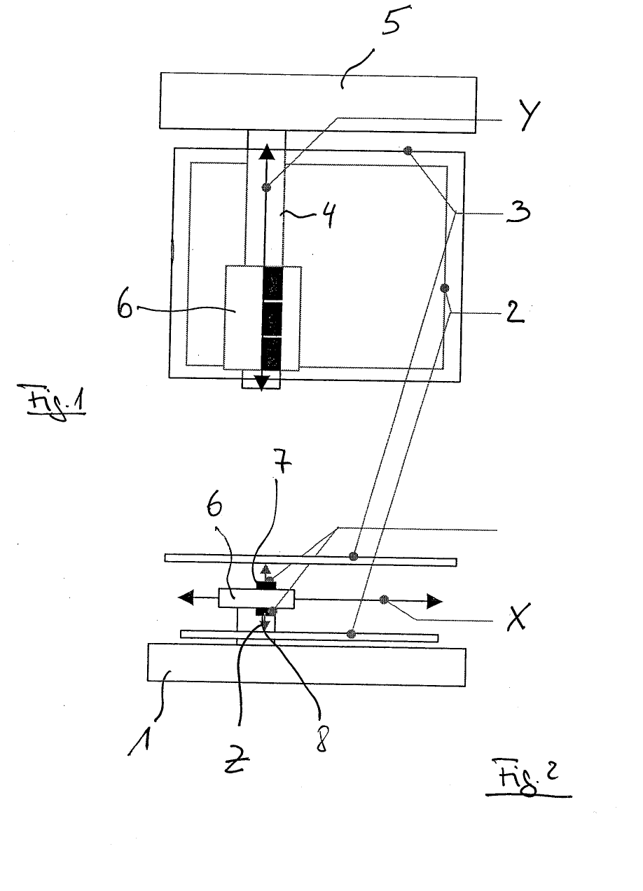

FIG. 1, an embodiment of an inventive device in the form of a schematic top view, and

FIG. 2, a side view of the embodiment according to FIG. 1.

The figures show an embodiment of an inventive device that features a schematically indicated base frame 1. A first element 2 in the form of a circuit board to be printed is arranged above this base frame 1 on a transport and holding device (not shown here). A second element 3 in the form of a printing stencil is arranged above the circuit board 2 in the Z-direction and held at this location by means of a frame arrangement (not shown here). In this case, the printing stencil features the pattern to be printed on the circuit board 2. The printing stencil 3 needs to be brought in contact with the circuit board 2 in a precisely fitted fashion in order to transfer the pattern onto the circuit board such that it is exactly arranged, for example, relative to connection points during the subsequent printing process.

A carrier 4 that essentially extends in the Y-direction and can be displaced in the X-direction by means of a schematically illustrated drive 5 is arranged between the circuit board 2 and the printing stencil 3. An upper and a lower line sensor 7 and 8 are respectively arranged on a support plate 6 on the carrier 4 and can be displaced in the X-direction by means of the drive 5 and the carrier 4. The support plate 6 can be simultaneously displaced on the carrier 4 in the Y-direction such that the entire mutually facing surfaces of the circuit board 2 and the printing stencil 3 can be optically scanned by the two line sensors 7 and 8. A comparison of the images of the corresponding regions of the circuit board 2 and the printing stencil 3 recorded by the two line sensors 7 and 8 with the aid of an evaluation unit (not shown here) makes it possible to easily determine the relative position between the circuit board and the printing stencil in a highly accurate fashion.

1. A device for determining the relative position in the X-Y plane between two essentially flat elements that are spaced apart in the Z-direction and are essentially arranged on top of one another, the device comprising at least one optical sensor that is arranged between the elements and is able to sense at least two points of the mutually facing surfaces of the elements;
an evaluation unit in which the images of the points can be evaluated with respect to their relative position in the X-Y plane; and
at least one line sensor included in the optical sensor that can be displaced relative to the two elements in such a way that the mutually facing surfaces of the elements can be optically scanned at least in sections in the manner of a scanner.

2. The device according to claim 1, wherein the line sensor is arranged on a carrier that can be essentially displaced in the X-Y plane between the elements by means of a drive.

3. The device according to claim 2, wherein the line sensor is movably arranged on the carrier.

4. The device according to claim 3, further comprising a second line sensor.

5. The device according to claim 4, characterized in that the at least one line sensor and the second line sensor are arranged on the carrier in such a way that at least one line sensor points to the assigned surface of the first element and the second line sensor points to the assigned surface of the second element.

6. The device according to claim 1, wherein the at least one line sensor is a color line sensor.

7. A system for printing circuit boards or substrates to be provided with electric strip conductors using a device according to one of the preceding claims, wherein the first of the two elements is a printing stencil and the second of the two elements is the circuit board to be printed or the substrate to be printed, respectively.
